(19) United States
(12) Patent Application Publication
(10) Pub. No.: US 2024/0058783 A1
(43) Pub. Date: Feb. 22, 2024

(54) APPARATUS FOR POLYMERIZING OR DEVOLATILIZING A COMPOSITION AND METHOD USING THE SAME

(71) Applicant: Avery Dennison Corporation, Mentor, OH (US)

(72) Inventors: Andrew P. FULL, State College, PA (US); Michael T. WATERMAN, Chardon, OH (US); David REYNOLDS, Felton, PA (US)

(21) Appl. No.: 18/260,979

(22) PCT Filed: Jan. 11, 2022
(86) PCT No.: PCT/US2022/011912

§ 371 Date: Jul. 11, 2023

Related U.S. Application Data
(60) Provisional application No. 63/135,771, filed on Jan. 11, 2021.

(51) Int. Cl. B01J 19/12; B01J 19/00; B01J 19/18; C08F 2/48

(52) U.S. Cl. CPC B01J 19/123; B01J 19/0006; B01J 19/0066; B01J 19/1881; C08F 2/48; B01J 2219/00087

(57) ABSTRACT

Apparatuses for polymerizing or devolatilizing a composition, especially one of high melt viscosity, are disclosed. Methods of polymerizing and devolatilizing a composition, especially one of high melt viscosity, are also disclosed.

### CROSS-REFERENCE TO RELATED APPLICATIONS

This application claims the benefit of U.S. Provisional Application No. 63/135,771 filed Jan. 11, 2021, the entire disclosure of which is incorporated herein by reference.

### FIELD OF THE INVENTION

The present invention generally relates to apparatuses for polymerizing or devolatilizing a composition, especially one of high melt viscosity, and to methods using the same.

### BACKGROUND OF THE INVENTION

The present invention generally relates to apparatus for polymerizing or devolatilizing a composition, especially one of high melt viscosity, and to methods using the same.

Commercial production of materials, such as polymers used for example in coatings, mastics, and adhesives, can take several hours or even days to convert the starting materials, including for example monomer(s), initiators, and any solvent or vehicles, to the final reacted product. Any changes made to the apparatus or method steps that reduce the duration of the process enable manufacturers to increase throughput for a given time period are desirable from a cost and time perspective. It is especially beneficial if these cycle time reductions not only maintain the quality of the material but improve the quality.

Because polymers, if in neat melt form without solvent or carrier, can become very viscous during production as the molecular weight builds, mixing of the reaction product can prove difficult. Furthermore, the high viscosity of the polymer melt makes the removal of residual volatiles, such as unreacted monomers, problematic. Thus, conventional means for reducing cycle time and removing unwanted volatile residuals in solvent-based and emulsion-based polymerization, may be a challenge in a process resulting in high molecular weight polymer in neat melt form during both the polymerization and devolatization phases.

The apparatuses and methods of the present invention are directed toward these, as well as other, important ends.

### SUMMARY OF THE INVENTION

The invention relates generally to apparatuses for polymerizing or devolatilizing a composition, especially one of high melt viscosity, and to methods using the same.

in one aspect, the invention is directed to an apparatus 1 for polymerizing or devolatilizing a composition. The apparatus comprises: a first reaction vessel 10 defining a first interior chamber 20, the first reaction vessel comprising: at least one first collar 30 providing access to the interior chamber; and at least one first probe assembly 40 supported by the first collar; wherein the first probe assembly comprises an emitter 50 for emitting light that polymerizes, crosslinks, or polymerizes and crosslinks the composition; at least one circulation loop 60 external to the first reaction vessel and defining a passage channel 65, the circulation loop comprising: a pump 70; at least one second collar 80 providing access to the passage channel; and at least one second probe assembly 90 supported by the second collar; wherein the second probe assembly comprises: an emitter 100 for emitting light that polymerizes, crosslinks, or polymerizes and crosslinks the composition.

In certain preferred aspects, the apparatus comprises optional devices. For example, the circulation loop may further comprise at least one of a mixer 110, an injector 120 for at least one entraining agent, a heat exchanger 130, and an analyzer 140.

In another aspect, the invention is directed to methods, comprising the steps of: forming a photopolymerizable reaction mixture in a reaction vessel; wherein the photopolymerizable reaction mixture comprises: monomers; a first photoinitiator; a second photoinitiator that is substantially non-photoreactive at the activation wavelengths of the first photoinitiator; irradiating the photopolymerizable reaction mixture with actinic radiation at at least one of the activation wavelengths of the first photoinitiator to at least partially polymerize the monomers to form a melt composition in the reaction vessel; wherein the melt composition comprises a polymer melt and any unreacted monomer; and circulating at least a portion of the melt composition outside of the reaction vessel.

The apparatuses and methods of the invention, which, among other things, utilize a circulation loop with a subsurface (that is, within material reaction) light emitter that polymerizes, crosslinks, or polymerizes and crosslinks the composition. The circulation loop also assists with top to bottom mixing in the first reaction vessel. The addition of an optional heat exchanger, especially one installed downstream of the light emitter in the circulation loop, helps to better maintain temperature after the flow (which is at a higher temperature due to the exothermic heat of polymerization) exits passed the subsurface light emitter. This temperature control supplements any jacket cooling used in the circulation loop. The addition of an optional entraining agent injector in the circulation loop further improves removal of unwanted volatile residuals during devolatilization. Finally, the addition of optional sensors in the circulation enables better monitoring of the reaction and reaction products, especially if the analysis can be performed on-line or in-line in real time, rather than off-line.

The summary of the invention is provided as a general introduction to some of the embodiments of the invention, and is not intended to be limiting. Additional example embodiments, including variations and alternative configurations, of the invention are provided herein.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. As will be realized, the subject matter described herein is capable of other and different embodiments and its several details are capable of modifications in various respects, all without departing from the claimed subject matter. Accordingly, the drawings and description are to be regarded as illustrative and not restrictive. In the drawings:

FIG. 1 illustrates an apparatus in one embodiment of the invention, shown with one reaction vessel.

FIG. 2 illustrates an apparatus in one embodiment of the invention, shown with two reaction vessels.

FIG. 3 illustrates the apparatus in one embodiment of the invention where multiple first probe assemblies are shown in the top portion of the first reaction vessel.

FIG. 4 illustrates the apparatus in one embodiment of the invention where a single probe assembly is shown in the circulation loop.

FIGS. 5A, 5B, and SC illustrate various views of a representative disengagement device, which is one embodiment of the heat exchanger 130.

### DETAILED DESCRIPTION OF THE ILLUSTRATED EMBODIMENTS

### Definitions

As employed above and throughout the disclosure, the following terms, unless otherwise indicated, shall be understood to have the following meanings.

As used herein, the terms “comprises,” “comprising,” “includes,” “including,” “has,” “having” or any other variation thereof, are intended are open-ended and cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” is employed to describe elements and components described herein. This is done merely for convenience and to give a general sense of the scope of the invention. This description should be read to include “one” or “at least one” and the singular also includes the plural, unless it is obvious that it is meant otherwise by the context. As used herein, the term “about,” when referring to a measurable value such as an amount, a temporal duration, and the like, is meant to encompass variations of ±10%, preferably, ±8%, more preferably, ±5%, even more preferably, ±1%, and yet even more preferably, ±0.1% from the specified value, as such variations are appropriate to perform the disclosed methods.

As used herein, a “composition” means a material that is capable of undergoing a chemical reaction, such as a polymerization, and which may change in chemical make-up over the course of the chemical reaction, such as being converted from an initial mixture of one or more monomers, initiator(s), optional vehicle or solvent, and other optional additives to the material comprising the polymerized residues of the one or more monomers and all intermediate stage there between.

As used herein, a “collar” means a visual access point that is transparent to at least certain wavelengths of light. Suitable examples of collars used in the context of this invention include, but are not limited to, a port, a nozzle, or a sight glass.

As used herein, an “entraining agent” means a substance, usually a fluid used to trap volatiles, such as residual monomers and solvent, and remove these volatiles, when, for example, pressure is reduced in the vessel. Suitable examples of entraining agents include, but are not limited to, steam, condensed water, nitrogen, argon, or carbon dioxide, or mixtures thereof.

As used herein, an “analyzer” means a device or system capable of making a measurement of the material flowing through the circulation loop. The analyzer may be capable of working in-line or on-line. Suitable examples of analyzers include, but are not limited to, Fourier Transform infrared (FTIR) spectrometer, viscometer, refractometer, and the like.

As used herein, “actinic radiation” means light capable of producing chemical changes by radiant energy especially in the visible (wavelength falling between about 380 to 750 nanometers) and ultraviolet (wavelength falling between about 10 and 400 nm) parts of the spectrum.

Apparatuses

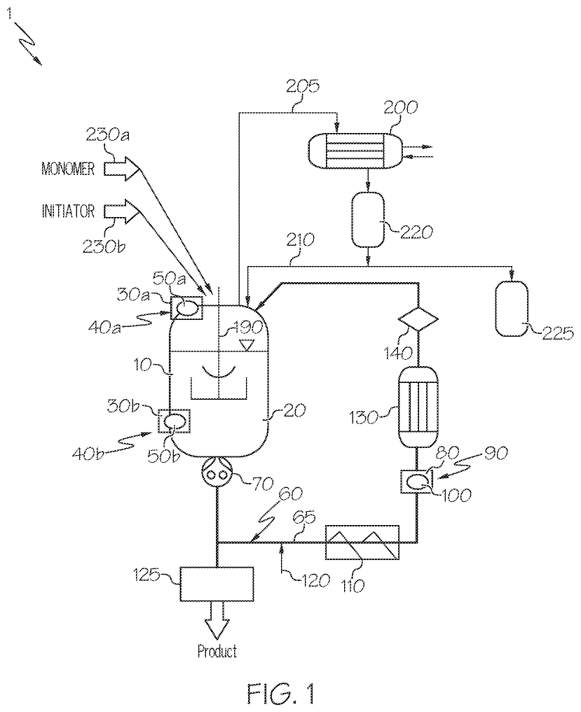

in a first embodiment, the invention is directed to an apparatus 1 for polymerizing or devolatilizing a composition. As shown with reference to FIG. 1, the apparatus comprises: a first reaction vessel 10 defining a first interior chamber 20, the first reaction vessel comprising: at least one first collar 30a, 30b providing access to the interior chamber; and at least one first probe assembly 40a, 40b supported by the first collar; wherein the first probe assembly comprises an emitter 50 for emitting light that polymerizes, crosslinks, or polymerizes and crosslinks the composition; at least one circulation loop 60 external to the first reaction vessel and defining a passage channel 65, the circulation loop comprising: a pump 70; at least one second collar 80 providing access to the passage channel; and at least one second probe assembly 90 supported by the second collar; wherein the second probe assembly comprises: an emitter 100 for emitting light that polymerizes, crosslinks, or polymerizes and crosslinks the composition.

In certain embodiments of the apparatus, the circulation loop further comprises a mixer 110.

In certain embodiments of the apparatus, the circulation loop further comprises an injector 120 for at least one entraining agent. In certain embodiments, the entraining agent is a material selected from steam, condensed water, nitrogen, argon, or carbon dioxide, or a mixture thereof. Steam is preferred.

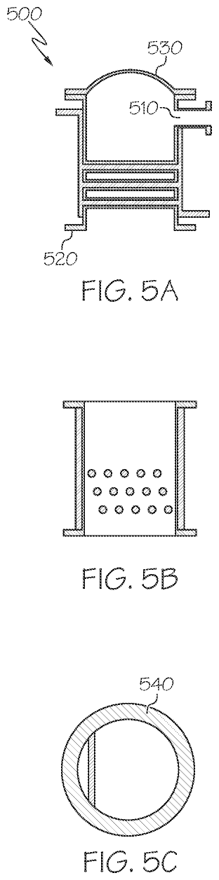

In certain embodiments of the apparatus, the circulation loop further comprises a heat exchanger 130. In certain embodiments, the heat exchanger may be a disengagement device 500, such as the device illustrated in FIGS. 5A, 5B, and SC. In FIGS. SA, 5B, and SC, the nozzle 510 is the inlet and may be connected to the external circulation loop 60. The bottom flange 520 may be mounted directly on top of the reactor 10. FIG. SA is a side view of the disengagement device with the lid 530 of the disengagement device 500 attached to the main body/vessel (not shown). The shaded areas indicate a heat transfer fluid. FIG. 5B is another side view of the disengagement device (rotated by 90°) with the lid removed, showing that the shell of the main body is jacketed. FIG. 5C is a bottom view of the main body 540 of the disengagement/heat exchanger vessel.

In certain embodiments of the apparatus, the circulation loop further comprises an analyzer 140. In certain embodiments, the analyzer is at least one device selected from the group consisting of Fourier Transform infrared spectrometer, viscometer (such as rotating cylinder type or dynamic mechanical spectrometer), and refractometer.

In certain embodiments of the apparatus, the circulation loop further comprises a filter 125, particularly a particulate filter.

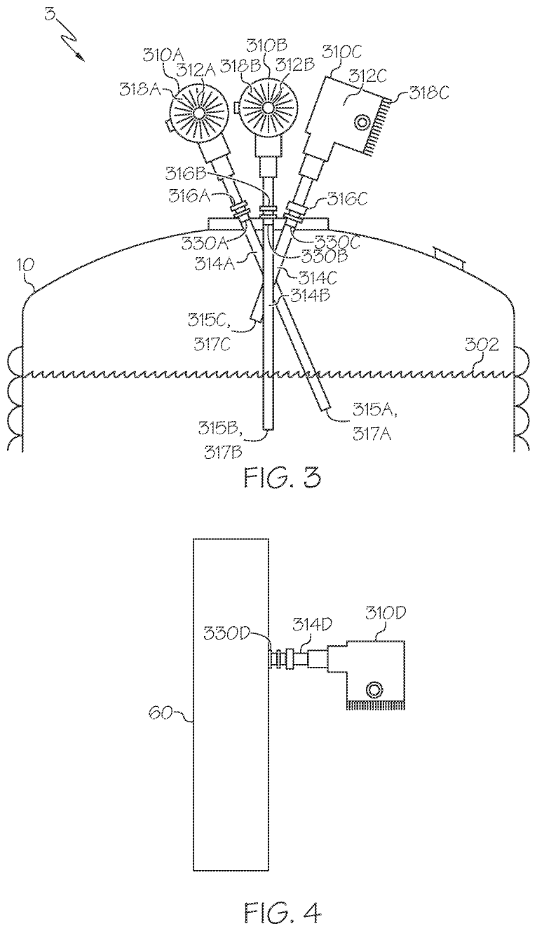

In certain embodiments of the apparatus, shown with reference to FIG. 3, the first probe assembly further comprises: a light tube 314A, 31413, 314C extending from the emitter 312A, 31213, 312C and at least partially disposed within the interior chamber of the reaction vessel; adjustable positioning provisions 316A, 31613, 316C for governing position of the light tube within the interior chamber of the first reaction vessel; and a cover 317A, 31713, 317C disposed at a distal end 315A, 31513, 315C of the light tube, wherein the cover is transparent or substantially transparent to passage of light emitted from the emitter.

In certain embodiments of the apparatus, shown with reference to FIG. 4, the second probe assembly 310D located in the circulation loop 60 further comprises a light tube 314D extending from the emitter toward the passage channel 60. Collar 330D is also shown.

In certain embodiments of the apparatus, the pump is a gear pump and is preferably positioned below the first reaction vessel.

In certain embodiments of the apparatus, wherein the first reaction vessel further comprises at least one stirrer 190.

In certain embodiments, the apparatus further comprises: at least one condenser 200; and a return line 210 to the first reaction vessel. In other embodiments, the apparatus also further comprises at least one condensate storage tank 220 and an optional secondary storage tank 225 between the condenser and the return line. The first interior chamber 20 is connected to the condenser 200 via line 205.

In certain embodiments, the light is actinic radiation.

In certain embodiments, the apparatus further comprises: at least one feed line 230 for components (monomer 230a and initiator 230b) of the composition; wherein the at least one feed line is connected to the first interior chamber.

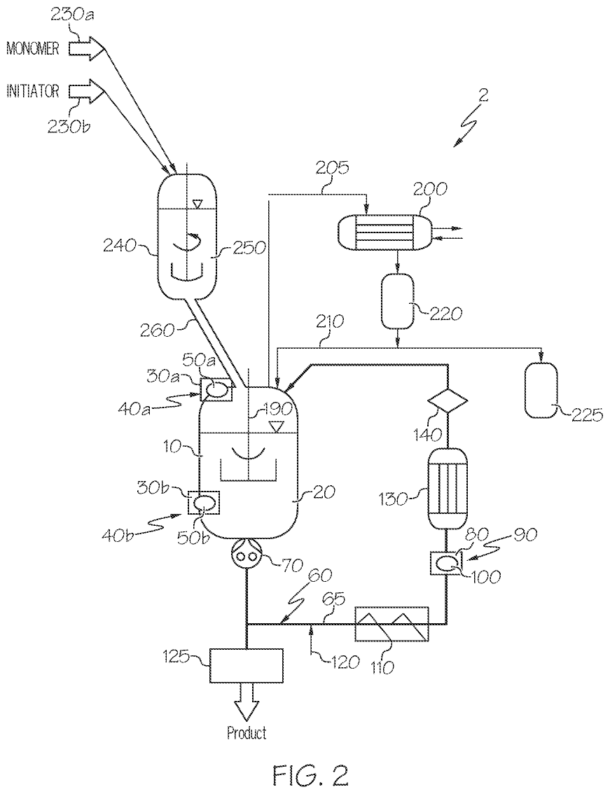

In certain embodiments, as shown with reference to FIG. 2, the apparatus 2 further comprises: a second reaction vessel 240 defining a second interior chamber 250; and at least one passageway 260 between the second reaction vessel and the first reaction vessel.

In certain embodiments, the first or second probe assembly is positionable to at least one position selected from the group consisting of a surface position, an angled surface position, a sub-surface position, and an angled sub-surface position. In certain embodiments, the apparatus comprises a single first or second probe assembly. In certain other embodiments, the apparatus comprises multiple first or second probe assemblies.

In certain embodiments, the first collar and at least one first probe assembly are located along a top wall of the first reaction vessel. In certain other embodiments, the first collar and at least one first probe assembly are located along a side wall of the reaction vessel. In certain other embodiments, the first collar and at least one first probe assembly are located along a bottom wall of the reaction vessel.

In certain embodiments, the first or second reaction vessel further comprises mixing provisions or mixers.

In one embodiment, the invention is directed to an apparatus for polymerizing and/or crosslinking an adhesive or pre-adhesive composition, the apparatus comprising: a first reaction vessel defining a first interior chamber, a circulation loop with at least one sight glass incorporated therein and providing visual access to the passage channel; and at least one sight glass incorporated in a wall of the first reaction vessel and providing visual access to the first interior chamber; at least one probe assembly adjacent to each of the sight glasses, each probe assembly comprising an emitter for emitting light that polymerizes and/or crosslinks the composition, the probe assembly positioned such that light emitted from the emitter is directed to the sight glass and passes into the first interior chamber of the reaction vessel or passage channel; wherein the sight glass is transparent or substantially transparent to passage of light emitted from the associated emitter.

In certain embodiments, the probe assembly further comprises a light tube disposed between the sight glass and the emitter. The sight glass may be located along a top wall, a side wall, and/or a bottom wall of the first reaction vessel.

In certain embodiments, the invention is directed to an apparatus for polymerizing and/or crosslinking an adhesive or pre-adhesive composition, the apparatus comprising: a first reaction vessel defining a first interior chamber, the vessel comprising mixing provisions having at least one blade; at least one baffle disposed within the first interior chamber of the reaction vessel, the baffle comprising at least one emitter for emitting light that polymerizes and/or crosslinks the composition. The baffle may be a uni-directional light emission baffle having a single face that emits light. The baffle may be oriented within the first interior chamber such that upon operation of the mixing provisions or mixer, the at least one blade moves toward the single face of the baffle that emits light. The optional second reaction vessel may also contain the same or different mixing provisions or mixers.

Methods

In certain embodiments, the invention is directed to methods, comprising the steps of: forming a photopolymerizable reaction mixture in a reaction vessel; wherein the photopolymerizable reaction mixture comprises: monomers; a first photoinitiator; a second photoinitiator that is substantially non-photoreactive at the activation wavelengths of the first photoinitiator; irradiating the photopolymerizable reaction mixture with actinic radiation at at least one of the activation wavelengths of the first photoinitiator to at least partially polymerize the monomers to form a melt composition in the reaction vessel; wherein the melt composition comprises a polymer melt and any unreacted monomer; and circulating at least a portion of the melt composition outside of the reaction vessel.

In certain embodiments, the method further comprises the step of mixing the melt composition with an entraining agent to form a diverted mixture comprising the polymer melt, any unreacted monomers, and the entraining agent.

In certain embodiments, the method further comprises the step of irradiating the melt composition with actinic radiation at least one of the activation wavelengths of the first photoinitiator to polymerize the unreacted monomers to form an irradiated diverted mixture.

In certain embodiments, the method further comprises the steps of: mixing the melt composition with an entraining agent to form a diverted mixture comprising the polymer melt, the unreacted monomers, and the entraining agent; and irradiating the diverted mixture with actinic radiation at at least one of the activation wavelengths of the first photoinitiator to polymerize the unreacted monomers to form an irradiated diverted mixture.

In certain embodiments, the method further comprises the step of: removing heat from the polymer melt.

In certain embodiments, the method further comprises the step of: testing the polymer melt, such as, for example, by using a technique selected from the group consisting of Fourier Transform infrared spectroscopy, rheology, and refractometry.

In certain embodiments, the method further comprises the step of: distilling the unreacted monomer and entraining agent in a separate vessel.

Other details of certain features of the apparatuses and methods of the invention are found in U.S. Pat. No. 5,772,851 and US-A1-2017/0240783, which are incorporated herein in their entirety.

When ranges are used herein for physical properties, such as molecular weight, or chemical properties, such as chemical formulae, all combinations, and subcombinations of ranges specific embodiments therein are intended to be included.

The disclosures of each patent, patent application, and publication cited or described in this document are hereby incorporated herein by reference, in their entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

1. An apparatus for polymerizing or devolatilizing a composition, the apparatus comprising:
a first reaction vessel defining a first interior chamber, the first reaction vessel comprising:
at least one first collar providing access to the interior chamber; and
at least one first probe assembly supported by the first collar;
wherein the first probe assembly comprises
an emitter for emitting light that polymerizes, crosslinks, or polymerizes and crosslinks the composition;
at least one circulation loop external to the first reaction vessel and defining a passage channel, the circulation loop comprising:
a pump;
at least one second collar providing access to the passage channel; and
at least one second probe assembly supported by the second collar;
wherein the second probe assembly comprises:
an emitter for emitting light that polymerizes, crosslinks, or polymerizes and crosslinks the composition.

2. The apparatus of claim 1,
wherein the circulation loop further comprises:
a mixer.

3. The apparatus of claim 1,
wherein the circulation loop further comprises:
an injector for at least one entraining agent.

4. The apparatus of claim 3,
wherein the entraining agent is a material selected from steam, condensed water, nitrogen, argon, or carbon dioxide or a mixture thereof.

5. The apparatus of claim 1,
wherein the circulation loop further comprises:
a heat exchanger.

6. The apparatus of claim 1,
wherein the circulation loop further comprises:
an analyzer.

7. The apparatus of claim 6,
wherein the analyzer is at least one device selected from the group consisting of Fourier Transform infrared spectrometer, viscometer, and refractometer.

8. The apparatus of claim 1,
wherein the first probe assembly further comprises:
a light tube extending from the emitter and at least partially disposed within the interior chamber of the reaction vessel;
adjustable positioning provisions for governing position of the light tube within the interior chamber of the first reaction vessel; and
a cover disposed at a distal end of the light tube, wherein the cover is transparent or substantially transparent to passage of light emitted from the emitter.

9. The apparatus of claim 1
wherein the second probe assembly-further comprises:
a light tube extending from the emitter toward the passage channel.

10. The apparatus of claim 1,
wherein the pump is a gear pump and is positioned below the first reaction vessel.

11. The apparatus of claim 1
wherein the first reaction vessel further comprises:
at least one stirrer.

12. The apparatus of claim 1, further comprising:
at least one condenser; and
a return line to the first reaction vessel.

13. The apparatus of claim 12, further comprising:
at least one condensate storage tank between the condenser and the return line.

14. The apparatus of claim 1, wherein the light is actinic radiation.

15. The apparatus of claim 1, further comprising:
at least one feed line for components of the composition;
wherein the at least one feed line is connected to the first interior chamber.

16. The apparatus of claim 1, further comprising:
a second reaction vessel defining a second interior chamber; and
at least one passageway between the second reaction vessel and the first reaction vessel.

17. A method, comprising:
forming a photopolymerizable reaction mixture in a reaction vessel;
wherein the photopolymerizable reaction mixture comprises:
monomers;
a first photoinitiator;
a second photoinitiator that is substantially non-photoreactive at the activation wavelengths of the first photoinitiator;
irradiating the photopolymerizable reaction mixture with actinic radiation at at least one of the activation wavelengths of the first photoinitiator to at least partially polymerize the monomers to form a melt composition in the reaction vessel;
wherein the melt composition comprises a polymer melt and any unreacted monomer; and
circulating at least a portion of the melt composition outside of the reaction vessel.

18. The method of claim 17, further comprising:
mixing the melt composition with an entraining agent to form a diverted mixture comprising the polymer melt, any unreacted monomers, and the entraining agent.

19. The method of claim 17, further comprising:
irradiating the melt composition with actinic radiation at at least one of the activation wavelengths of the first photoinitiator to polymerize the unreacted monomers to form an irradiated diverted mixture.

20. The method of claim 17, further comprising:
mixing the melt composition with an entraining agent to form a diverted mixture comprising the polymer melt, the unreacted monomers, and the entraining agent; and
irradiating the diverted mixture with actinic radiation at least one of the activation wavelengths of the first photoinitiator to polymerize the unreacted monomers to form an irradiated diverted mixture.

21. The method of claim 17, further comprising:
removing heat from the polymer melt.

22. The method of claim 17, further comprising:
testing the polymer melt.

23. The method of claim 22,
wherein the testing is a technique selected from the group consisting of Fourier Transform infrared spectroscopy, rheology, and refractometry.

24. The method of claim 17, further comprising:
distilling the unreacted monomer and entraining agent in a separate vessel.
